(19) United States
(12) Patent Application Publication
(10) Pub. No.: US 2014/0228518 A1
(43) Pub. Date: Aug. 14, 2014

(54) TOUGHENED COMINGLED POST-CONSUMER THERMOPLASTICS AND METHOD FOR RECYCLING THERMOPLASTIC WASTE

(71) Applicant: King Abdulaziz City for Science and Technology, Riyadh (SA)

(72) Inventors: Fares D. Alsewailem, Riyadh (SA); Abdulmajeed M. Algaflah, Riyadh (SA); Yazeed A. Binkheder, Riyadh (SA)

(73) Assignee: King Abdulaziz City for Science and Technology, Riyadh (SA)

(21) Appl. No.: 14/254,273

(22) Filed: Apr. 16, 2014

Related U.S. Application Data
(62) Division of application No. 13/552,154, filed on Jul. 18, 2012.

(51) Int. Cl. C08L 67/03; B29B 17/00

(52) U.S. Cl. CPC C08L 67/03; B29B 17/00
USPC 525/64

(57) ABSTRACT

Methods for obtaining toughened products from unsorted post-consumer plastics is disclosed. A toughened plastic composition is further disclosed, which includes a first thermoplastic polymer, a different second thermoplastic polymer, and a maleic anhydride-grafted ethylene/propylene rubber compatibilizer.

### FIELD OF THE INVENTION

The invention relates to methods for obtaining toughened products from unsorted post-consumer plastics, such as recycled thermoplastic waste materials, and more particularly to a toughened plastic composition of polyethylene terephthalate and polyethylene.

### BACKGROUND OF THE INVENTION

Modern societies suffer from increasing amounts of plastic waste materials in large part due to lack of efficient and reliable management. Polymeric waste mainly in the form of plastic articles is increasing daily. Recycling of such materials faces many challenges, such as cost and poor quality of recycled products.

Worldwide, many millions of tons of plastics (or polymers) are generated annually for consumer use in households and commercial establishments. Much of such amounts of post-consumer plastic enter the municipal solid waste (MSW) stream with plastics representing upwards to 20% of an MSW landfill's volume.

The majority of post-consumer waste plastic originates from packaging and containers. This includes water and soft drink bottles and cosmetic containers, as well as disposable plates, cups and cutlery. Soft drink, water and dairy product containers are frequently produced from polyethylene terephthalate (PET). Water jugs, milk jugs and shampoo bottles are frequently fashioned from high density polyethylene (HDPE). Disposable cups, plates and cutlery are frequently made from polystyrene (PS).

Most residential recycling programs in the United States and elsewhere recycle only the polyethylene terephthalate (PET) and the high density polyethylene (HDPE) portions of their collected plastics. The plastics that are not recycled are landfilled. Overall, thus, only a small fraction of all plastics produced are recycled.

One factor which influences this relatively low recycling rate is the potential need to separate recycled plastics by type. Products prepared from unseparated recycled mixtures comprising articles of a variety of incompatible plastic types can exhibit physical, structural or other properties and characteristics which are inferior to products made from their individual parent materials. However, the practical possibilities of completely sorting mixtures of potentially incompatible plastics into groups of like plastics are very limited from the technical and economic standpoints. Prior technology thus creates the problem of what to do with unseparated mixtures of post-consumer plastic articles. Some earlier efforts at recycling mixed plastic wastes have been attempted, but have been unsuccessful for various reasons.

U.S. Pat. No. 4,250,222 to Mavel et al. discloses a process for manufacturing finished and semi-finished articles from mixtures of normally incompatible synthetic resin scrap materials. The process comprises coarsely grinding thermoplastic scrap materials containing two or more mutually incompatible thermoplastic resins and possibly up to 25 parts % by weight of foreign materials, incorporating into the coarsely ground thermoplastic resin mixture through the application of heat, pressure, or a sequential or simultaneous application of heat and pressure, from about 5 to about 25 parts by weight of a fibrous material, the individual fibers in said fibrous material having an average length equal to at least three times the average size of the fragments constituting the coarsely ground thermoplastic resin mixture, and finally, forming the resin/fiber mass into finished or semi-finished article employing known and conventional techniques.

U.S. Pat. No. 5,859,071 to Young et al. discloses a polymeric blend formed from recycled carpet scrap and selected compatibilizing agents and/or a poly(ethylene-co-vinylacetate) and the products produced from such blend.

U.S. Pat. No. 6,180,685 to Khait discloses a method of making polymeric particulates wherein polymeric scrap material, virgin polymeric material and mixtures thereof are supplied to intermeshing extruder screws which are rotated to transport the polymeric material along their length and subject the polymeric material to solid state shear pulverization and in-situ polymer compatibilization, if two or more incompatible polymers are present. Uniform pulverized particulates are produced without addition of a compatibilizing agent. The pulverized particulates are directly melt processable (as powder feedstock) and surprisingly yield a substantially homogeneous light color product.

EP 1 288 257 discloses a method of manufacturing articles from recycled plastic materials which comprises forming an agglomerate by mixing thermoplastic matter with a thermoplastic elastomer and a 8,8′-dicumenyl peroxide at 110-125 degrees C. before transforming into articles.

U.S. Published Patent Application No. 2012/0022216 to Alsewailem, incorporated by reference herein in its entirety, discloses a process for the preparation of thermal insulation sheets fashioned from certain unseparated mixtures of post-consumer plastic articles. The mixtures of such articles used are those which contain articles made of polyethylene terephthalate (PET) and polystyrene (PS) and optionally also articles made of high density polyethylene (HDPE). An unseparated mixture of such articles is provided in Step A of the process. This mixture is then crushed and shredded in Step B to form plastic flakes, and these plastic flakes are then homogenized in Step C to form a uniform blend of the several plastic types. Homogenization of the flakes can be carried out either by melt-blending them or by further comminution to produce very fine particles of the mixed plastics. The resulting homogenized mixture of plastic types is then compression molded in Step D into sheets ranging in thickness from about 3 to 10 mm. It has been discovered that such molded plastic sheets exhibit thermal conductivity characteristics which make them suitable for use as thermal insulation in a wide variety of insulation applications and contexts.

Given the foregoing situation, it would be advantageous to develop processes for producing commercially useful products from mixtures of recycled post-consumer plastic articles without the need to completely separate such articles into different streams of articles of like plastic type. Such processes could create an incentive to recycle more of the available post-consumer plastic articles, thereby sending fewer of such post-consumer plastic articles to landfills. Accordingly, there exists a need in the art to overcome the deficiencies and limitations described hereinabove.

### SUMMARY OF THE INVENTION

In embodiments, a comingled polymer composition comprises a first thermoplastic polymer, a second thermoplastic polymer, different from the first thermoplastic polymer, and a maleic anhydride-grafted ethylene/propylene rubber compatibilizer.

In further embodiments, a process for recycling thermoplastic waste comprises melt blending first and second melt-immiscible thermoplastics with a maleic anhydride-grafted ethylene/propylene rubber compatibilizer.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows results of Izod impact testing on various compatibilized blends of recycled polyethylene terephthalate (PET) and recycled high density polyethylene (HDPE);

FIG. 2 shows results of tensile strength testing on various compatibilized blends of recycled polyethylene terephthalate (PET) and recycled high density polyethylene (HDPE);

FIG. 3 shows comparative results of Izod impact testing on the compatibilized blends of PET/HDPE and non-compatibilized blends of the same components; and

FIG. 4 shows comparative results of tensile strength testing on the compatibilized blends of PET/HDPE and non-compatibilized blends of the same components.

### DETAILED DESCRIPTION OF THE INVENTION

The invention relates to methods for obtaining toughened products from unsorted post-consumer plastics, such as recycled thermoplastic waste materials, and more particularly to a toughened plastic composition of polyethylene terephthalate and polyethylene. More specifically, the present invention relates to toughened plastic compositions which include at least two different thermoplastic materials and a maleic anhydride-grafted ethylene/propylene rubber (EP-g-MA) compatibilizer. Advantageously, at least one of the thermoplastic materials is a post-consumer waste thermoplastic material, or both of the thermoplastic materials can be post-consumer waste thermoplastic materials.

Given the situation of the known art, it would be advantageous to develop processes for producing commercially useful products from mixtures of recycled post-consumer plastic articles without the need to completely separate such articles into different streams of articles of like plastic type. Such processes could create an incentive to recycle more of the available post-consumer plastic articles, thereby sending fewer of such post-consumer plastic articles to landfills. The invention described and claimed herein addresses this need for technology for converting unseparated, i.e., at least not completely separated, mixtures of different types of post-consumer plastic articles into commercially useful structures. The invention herein thus provides a solution to the problem of how to commercially utilize unseparated mixtures of post-consumer plastic articles.

As should be understood by those of skill in the art, the present invention advantageously provides processes for producing commercially useful products from mixtures of recycled post-consumer plastic articles without the need to completely separate such articles into different streams of articles of like plastic type. Such processes create an incentive to recycle more of the available post-consumer plastic articles, thereby sending fewer of such post-consumer plastic articles to landfills. The invention thus addresses the need for converting unseparated, i.e., at least not completely separated, mixtures of different types of post-consumer plastic articles into commercially useful structures. The invention herein thus provides a solution to the problem of how to commercially utilize unseparated mixtures of post-consumer plastic articles.

A great deal of post-consumer plastics, especially household plastic waste, is composed of high density polyethylene (HDPE) and polyethylene terephthalate (PET). These are two quite different polymeric materials with varying chemical natures and properties, which when melt blended tend to form immiscible blends with poor properties. In particular, the post-consumer plastic wastes are melt-immiscible because of being from plastics having different monomer repeating units, such as where one of the waste materials is predominantly non-polar, derived from hydrocarbon monomer units, such as high density polyethylene, medium density polyethylene, low density polyethylene or even linear low density polyethylene, polypropylene, polybutylene, polystyrene, or the like, and the other is a more polar polymer, such as one containing more than just hydrogen and carbon atoms, for example, having monomer units containing polar moieties, such as polyesters, including polyethylene terephthalate; polyamides, including nylon-6 or nylon-6,6; polyvinylchloride, ionomers or other such thermoplastics. However, in implementing the present invention, the process for recycling thermoplastic waste comprises melt blending first and second melt-immiscible thermoplastics with a maleic anhydride-grafted ethylene/propylene rubber compatibilizer.

Various compatibilizers have been explored for combining mixed, melt-immiscible plastic wastes. For example, U.S. Pat. No. 4,250,222 discloses the use of ethylene/propylene rubber as a compatibilizer for mixtures of polyethylene and polypropylene. U.S. Pat. No. 5,824,745 discloses the use of an ethylene-octene copolymer and a polyamide for blending with post-consumer recyclable plastics. U.S. Pat. No. 5,859,071 discloses polymeric blends of recycled carpet scrap with a number of possible compatibilizers, such as acrylic acid-modified polypropylene, anhydride-modified polymers including Bynel XCA 302 and CXA E361, and a maleic anhydride-functionalized copolymer of polystyrene endblocks and poly(ethylene/butylene) midblocks, known as Kraton FG 1901X. However, none of these proposed combinations have become commercially acceptable.

In a publication presented in the ANTEC-08 (Alsewailem, “PET/EP-g-MA BLEND SYSTEM: A PRACTICAL WAY TO RECYCLE POST-CONSUMER PLASTICS INTO VALUE ADDED PRODUCTS”), it was shown that 40 wt % of EP-g-MA can increase the toughness of post-consumer PET by a factor of greater than 3. However, it has been discovered that incorporation of these EP-g-MA compatibilizer materials is effective to compatibilize mixed, melt-immiscible thermoplastic polymers, such as those obtained from post-consumer waste. For example, when a waste stream of varying compositions of PET/HDPE, normally melt-immiscible, was incorporated with about 1 wt % to about 30 wt % of ethylene/propylene rubber grafted with maleic anhydride (EP-g-MA), relative to weight of the entire composition, a very tough material was obtained. Polymer compositions according to the present invention have been determined to have Izod impact strengths from about 100 J/m to about 400 J/m and tensile strengths from about 10 MPa to about 30 MPa.

For example, in one embodiment, a first thermoplastic polymer is high density polyethylene, a second thermoplastic polymer is polyethylene terephthalate and an amount of the EP-g-MA compatibilizer is from about 1 wt % to about 30 wt %. In another embodiment, the polymer composition contains from about 20 wt % to about 60 wt % high density polyethylene, from about 10 wt % to about 70 wt % polyethylene terephthalate, and from about 10 wt % to about 30 wt % of the EP-g-MA compatibilizer. In preferred embodiments, the polymer composition contains about 20 wt % high density polyethylene, about 70 wt % polyethylene terephthalate, and about 10 wt % of the EP-g-MA compatibilizer; or about 40 wt % high density polyethylene, about 40 wt % polyethylene terephthalate, and about 20 wt % of the EP-g-MA compatibilizer; or about 60 wt % high density polyethylene, about 10 wt % polyethylene terephthalate, and about 30 wt % of the EP-g-MA compatibilizer.

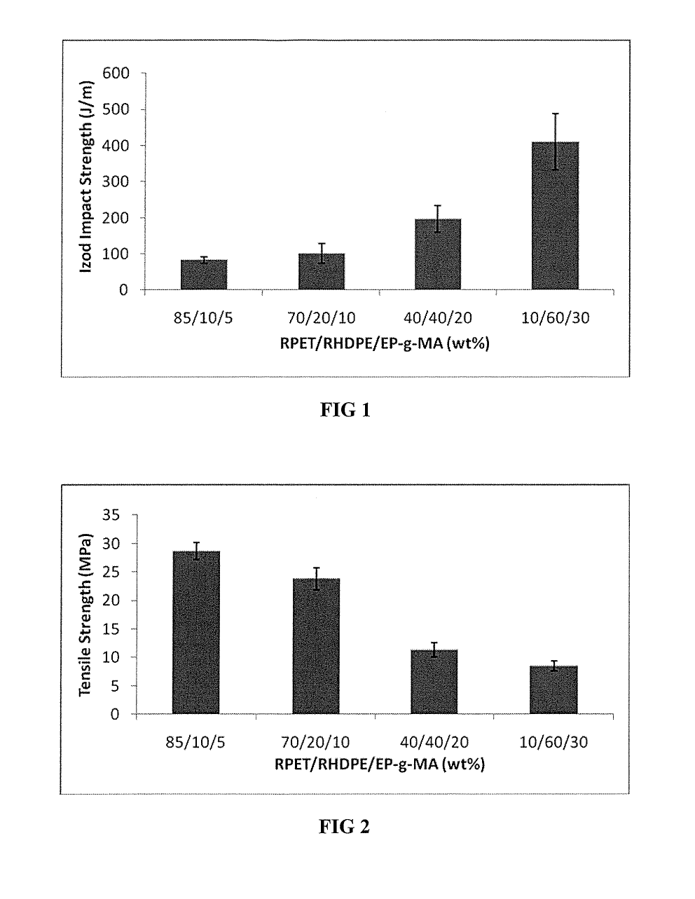

FIGS. 1 and 2 show the Izod impact strengths and tensile strengths of various blends of post-consumer PET/HDPE mixed with different loadings of EP-g-MA compatibilizer in accordance with the present invention. While there is a tradeoff between toughness and stiffness of the resulting blends, toughness represented by Izod impact strength is seen to increase tremendously.

Using this strategy (i.e., melt blending of comingled post-consumer thermoplastics), sorting and segregation of plastic waste is not needed and products obtained thereby have high values of toughness. This strategy may be applied to various thermoplastic waste streams or segregated plastic wastes. For example, EP-g-MA may be successfully melt blended with various thermoplastic waste materials, such as PET, HDPE, low density polyethylene (LDPE), polystyrene (PS), polypropylene (PP), polyvinyl-chloride (PVC) and others, either comingled or individually. Advantageously, a variety of new products can be produced by processing post-consumer plastics in the presently disclosed manner, such as knee pads, helmets, and the like.

At the same time, the best combinations of PET/HDPE/EP-g-MA based on properties needed, may be selected. For products with moderate stiffness and high toughness, weight blends in the range 70/20/10 and 40/40/20 are selected. If greater toughness is desired, a 10/60/30 blend system may be selected, for example.

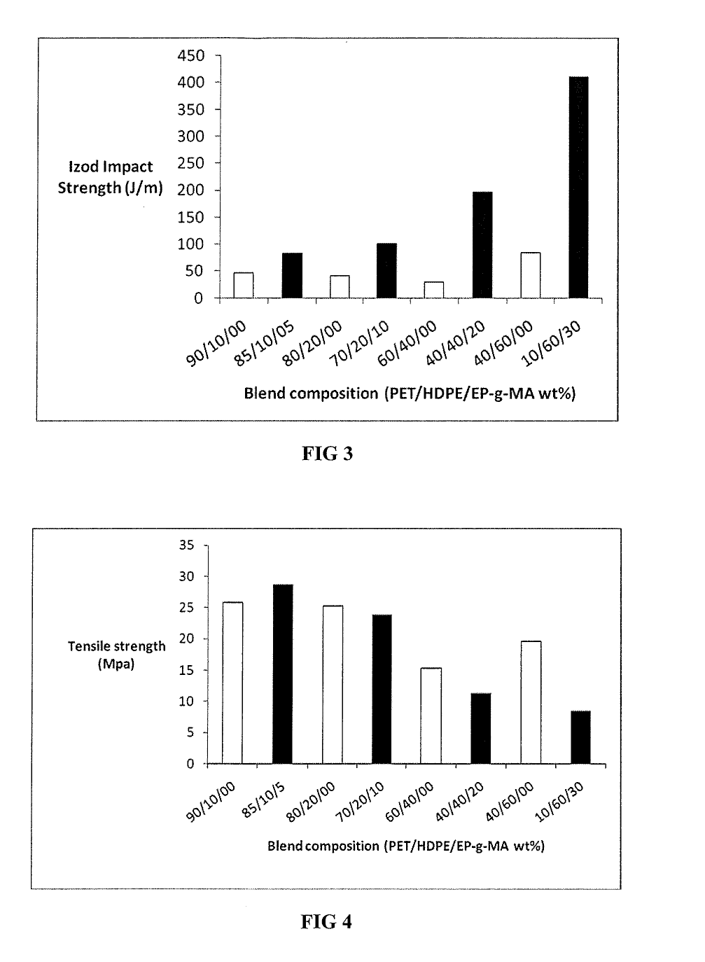

FIGS. 3 and 4 show comparison data between neat post-consumer PET/HDPE blends and the EP-g-MA toughened blends according to the present invention. It can be seen that while incorporating from about 1 wt % to about 30 wt % of EP-g-MA tends to tremendously increase the toughness, the tensile strength of toughened blends decreases slightly relative to un-toughened blends.

### EXAMPLES

Various concentrations of two post-consumer thermoplastics, r-PET (recycled PET) and r-HDPE (recycled HDPE), were melt blended with various concentrations of an EP-g-MA compatibilizer, Exxelor VA 1803 (Tg −57° C.) obtained from ExxonMobil, in a 26 mm co-rotating twin screw extruder (Scientific LTE26-32 by Lab. Tech., Ltd.) at 60 rpm and a temperature of about 280° C. to melt-extrude pellets of about 4 mm in diameter. Four different weight ratio combinations of r-PET/r-HDPE/EP-g-MA were used: 85/10/5; 70/20/10; 40/40/20 and 10/60/30.

After extrusion, the pellets were melted in an LMM cup of a Dynisco Mini Molder at 290° C. and then injected into rectangular molds to form samples having dimensions suitable for Izod Impact Strength and Tensile Strength testing according to ASTM D-256 and ASTM D-1708, respectively. Testing data for these compatibilized melt blended products is provided in FIGS. 1 and 2.

For comparison, blends of the same recycled polymer components were prepared without the EP-g-MA compatibilizer, by adding an amount of PET equivalent to the amount of EP-g-MA compatibilizer removed from each of the exemplary blend formulations, melt-extruded into pellets, remelted, molded and tested as set forth above. The results of these comparison tests are illustrated in FIGS. 3 (Izod impact strength) and 4 (Tensile strength).

As can be seen from FIG. 1, in each case the incorporation of the EP-g-MA compatibilizer resulted in improvements in Izod impact strength, especially as compared to the non-compatibilized products (FIG. 3). Unexpectedly, in some cases tensile strength was better or almost unaffected by incorporation of the compatibilizer (FIG. 4), relative to the non-compatibilized products.

In conclusion, recycled, post-consumer thermoplastics, especially PET/HDPE comingled waste, may not need to be segregated and one may obtain very tough material out of its stream by simple melt blending with elastomeric thermoplastics such as EP-g-MA.

The foregoing examples have been provided for the purpose of explanation and should not be construed as limiting the present invention. While the present invention has been described with reference to exemplary embodiments, changes may be made, within the purview of the appended claims, without departing from the scope and spirit of the present invention in its aspects. Also, although the present invention has been described herein with reference to particular materials and embodiments, the present invention is not intended to be limited to the particulars disclosed herein; rather, the present invention extends to all functionally equivalent structures, methods and uses, such as are within the scope of the appended claims.

What is claimed is:

1. A process for recycling thermoplastic waste, comprising melt blending first and second melt-immiscible thermoplastics with a maleic anhydride-grafted ethylene/propylene rubber compatibilizer.

2. The process of claim 1, further comprising obtaining comingled, post-consumer thermoplastic waste containing the first and second melt-immiscible thermoplastics.

3. The process of claim 2, wherein the first thermoplastic is polyolefin and the second thermoplastic is polyester.

4. The process of claim 3, wherein the first thermoplastic is high density polyethylene and the second thermoplastic is polyethylene terephthalate.

5. The process of claim 4, wherein the thermoplastic waste contains from about 20 wt % to about 60 wt % high density polyethylene and from about 10 wt % to about 70 wt % polyethylene terephthalate, and is blended with from about 10 wt % to about 30 wt % of the compatibilizer.

6. The process of claim 5, wherein the thermoplastic waste contains about 20 wt % high density polyethylene and about 70 wt % polyethylene terephthalate, and is blended with about 10 wt % of the compatibilizer.

7. The process of claim 5, wherein the thermoplastic waste contains about 40 wt % high density polyethylene and about 40 wt % polyethylene terephthalate, and is blended with about 20 wt % of the compatibilizer.

8. The process of claim 1, wherein the first and second melt-immiscible thermoplastics comprise a first thermoplastic polymer and a second thermoplastic polymer, different from the first thermoplastic polymer.

9. The process of claim 8, wherein the first and second thermoplastic polymers are melt-immiscible with each other.

10. The process of claim of claim 9, wherein at least one of the first and second thermoplastic polymers is post-consumer waste polymer.

11. The process of claim 9, wherein both of the first and second thermoplastic polymers are post-consumer waste polymer.

12. The process of claim 8, wherein:
the first thermoplastic polymer is one which contains substantially only hydrocarbon monomer units; and
the second thermoplastic polymer is one which contains hydrocarbon monomer units polymerized with monomers containing polar moieties.

13. The process of claim 12, wherein the first thermoplastic polymer is a polyolefin selected from the group consisting of high density polyethylene, low density polyethylene, polypropylene and polystyrene, and the second thermoplastic polymer is selected from the group consisting of polyester, polyamide and polyvinyl chloride.

14. The process of claim 8, wherein the first thermoplastic polymer is high density polyethylene, the second thermoplastic polymer is polyethylene terephthalate and an amount of compatibilizer is from about 1 wt % to about 30 wt %.

15. The process of claim 14, wherein the of claim 1, wherein the high density polyethylene is from about 20 wt % to about 60 wt %, the polyethylene terephthalate is from about 10 wt % to about 70 wt %, and the compatibilizer is from about 10 wt % to about 30 wt %.
